(19) United States
(12) Patent Application Publication
(10) Pub. No.: US 2017/0035535 A1
(43) Pub. Date: Feb. 9, 2017

(54) SCREW COUPLING STRUCTURE FOR PREVENTING LOOSENING AND METHOD FOR PRODUCING SCREW COUPLING STRUCTURE FOR PREVENTING LOOSENING

(71) Applicant: KOREA INSTITUTE OF SCIENCE AND TECHNOLOGY, Seoul (KR)

(72) Inventors: Kwang Koo JEE, Seoul (KR); Ji Young BYUN, Seoul (KR)

(73) Assignee: KOREA INSTITUTE OF SCIENCE AND TECHNOLOGY, Seoul (KR)

(21) Appl. No.: 15/304,713

(22) PCT Filed: Apr. 14, 2015
(86) PCT No.: PCT/KR2015/003734

§ 371 Date: Oct. 17, 2016

(30) Foreign Application Priority Data
Apr. 17, 2014 (KR) 10-2014-0046194
Apr. 14, 2015 (KR) 10-2015-0052286

(51) Int. Cl. A61C 8/00; F16B 39/284; F16B 39/02

(52) U.S. Cl. CPC A61C 8/0068; F16B 39/02; F16B 39/284; A61C 2201/007

(57) ABSTRACT

The present disclosure relates to a screw coupling structure for preventing loosening, and more particularly, to a screw coupling structure for preventing loosening for preventing loosening between a screw portion and an engagement portion, which includes the screw portion having a predetermined length and the engagement portion having a screw hole through which the screw portion is inserted and engaged, in which the screw portion is formed of a shape memory alloy deformable by an external force applied thereto at a temperature lower than a predetermined threshold temperature and recoverable from the deformation by heating to a temperature higher than the threshold temperature.

### TECHNICAL FIELD

The present invention relates to a screw coupling structure for preventing loosening and method for producing screw coupling structure for preventing loosening, and more particularly, to a screw coupling structure for preventing loosening deformable by an external force applied thereto at a temperature lower than a predetermined threshold temperature and that recoverable from the deformation upon application of a temperature higher than the threshold temperature, thereby preventing loosening.

### BACKGROUND ART

A screw, which is one of seven inventions in human history, has a serious problem of being loosened by a stress, such as external vibration, over time. In particular, a screw used inside a human body is difficult to tighten once being loosened, needing a definite measure for the problem.

As one of applications of the screw, a dental implant is configured as shown in FIG. 1. A fixture is first implanted into an alveolar bone and an abutment and a connection screw are connected between the fixture and the alveolar bone to lift a crown. The connection screw may be loosened, causing several problems such as shaking of the crown. In case of an implant, an internal screw is known as being loosened by a significant load or vibration repetitively applied when a person chews food, and sometimes, an electric toothbrush speeds up such an implant screw-loosening phenomenon.

As illustrated in FIG. 2, a general screw, because of having a gap in a screw portion, may be engaged and after engagement, bevels at a side are bonded by a frictional force. Once an external stress is generated, a space is eventually generated in a bonding portion of a screw thread, such that a left side portion under a head of the screw is widened and thus the screw is loosened. That is, a male screw needs to be elastically stretched in a longitudinal direction, and if an elastic tensile strength is lost, the screw is loosened. In case of general metal, a force/displacement has a steep inclination and the amount of deformation capable of elastic deformation merely corresponds to a tension of 0.3-0.5%. Thus, an elastic force is significantly reduced even by slight movement caused by an external force, making the metal to easily move and thus easily loosening the screw. Even a washer, which is most commonly used for preventing loosening of the screw, is eventually intended to increase the elasticity. However, a washer formed of general metal also merely extends a time until being loosened, failing in essentially solving the problems.

### DETAILED DESCRIPTION OF THE INVENTION

### Technical Problem

The present disclosure has been made to solve the foregoing problems, and provides a screw coupling structure for preventing loosening deformable by an external force applied thereto at a temperature lower than a predetermined threshold temperature and is recoverable from the deformation upon application of a temperature higher than the threshold temperature, thereby preventing the loosening.

### Technical Solution

In order to achieve the foregoing objects, a screw coupling structure for preventing loosening configured to prevent loosening between a screw portion and an engagement portion includes the screw portion having a predetermined length and the engagement portion having a screw hole through which the screw portion is inserted and engaged, in which the screw portion is formed of a shape memory alloy deformable by an external force applied thereto at a temperature lower than a predetermined threshold temperature and is recoverable from the deformation by heating to a temperature higher than the threshold temperature.

Preferably, the screw portion has a male screw formed on an outer surface thereof, the engagement portion has a female screw formed on an inner surface of the screw hole, and screw portion is at least partially compressed or stretched in a longitudinal direction at a temperature lower than the threshold temperature, and, when heated to a temperature higher than the threshold temperature while being inserted into the engagement portion, expands or contracts in the longitudinal direction and recovers to a pre-deformed state, exerting stress on the male screw threads and the female screw threads.

Preferably, the screw portion is compressed by being pressurized in a width direction at a temperature lower than the threshold temperature, and when expanding in the width direction by being heated to a temperature higher than the threshold temperature while being inserted into the engagement portion, the screw portion exerts stress to the screw hole in the width direction.

A screw soupling structure for preventing loosening configured to prevent loosening between a screw portion and an engagement portion according to an embodiment of the present disclosure includes the screw portion having a predetermined length and a head in an upper portion thereof, the engagement portion having a screw hole through which the screw portion is inserted and engaged, and a washer disposed between the engagement portion and the head when the screw portion is inserted into the engagement portion, in which the screw portion has a male screw formed on an outer surface thereof, the engagement portion has a female screw formed on an inner surface of the screw hole, and the washer is formed of a shape memory alloy that is deformable by an external force applied thereto at a temperature lower than a predetermined threshold temperature and recoverable from the deformation by heating to a temperature higher than the threshold temperature.

Preferably, the washer is compressed in a longitudinal direction at a temperature lower than the threshold temperature, and, when heated to a temperature higher than the threshold temperature while disposed between the engagement portion and the head, expands in the longitudinal direction and recovers to a pre-deformed state, exerting stress on the male screw threads and the female screw threads.

Preferably, the shape memory alloy includes a Ni—Ti alloy.

Preferably, the threshold temperature is in a range between about 20° C. and about 30° C.

A method and method for producing screw coupling structure for preventing loosening according to the present disclosure includes providing a screw portion formed of a shape memory alloy deformable at a temperature lower than a predetermined threshold temperature and recoverable from the deformation by being heated to a temperature higher than the threshold temperature, providing an engagement portion having a screw hole through which the screw portion is inserted, treating the screw portion at a temperature lower than the threshold temperature, engaging the engagement portion with the screw portion by inserting the screw portion into the screw hole, and recovering the screw portion to a pre-deformed state by heating the screw portion to a temperature higher than the threshold temperature.

Preferably, the processing of the screw portion at a temperature lower than the threshold temperature includes stretching or compressing at least a portion of the screw portion in a longitudinal direction and forming male screw threads in the screw portion.

Preferably, the processing of the screw portion at a temperature lower than the threshold temperature includes compressing the screw portion in a width direction.

A and method for producing screw coupling structure for preventing loosening according to an embodiment of the present disclosure includes providing a screw portion having a predetermined length and a head at an end portion thereof, providing an engagement portion having a screw hole through which the screw portion is inserted, providing a washer formed of a shape memory alloy that is deformed at a temperature lower than a predetermined threshold temperature and is recoverable from the deformation by being heated to a temperature higher than the threshold temperature, and engaging the engagement portion with the screw portion by inserting the screw portion into the screw hole, wherein the engaging includes disposing the washer between the head and the engagement portion.

Preferably, the method further includes between the providing of the washer and the disposing of the washer between the head and the engagement portion, compressing the washer in a longitudinal direction by compressing the washer at a temperature lower than the threshold temperature, and after the disposing of the washer between the head and the engagement portion, heating the washer to a temperature higher than the threshold temperature to expand the washer in the longitudinal direction and recover the washer to a pre-deformed state.

Preferably, the providing of the washer includes providing a coil formed of a shape memory alloy and providing a plurality of washers having a shape of ring, wherein the providing of the washer includes longitudinally cutting a side of the coil in a diameter direction.

### Advantageous Effects of the Invention

In a screw coupling structure for preventing loosening according to the present disclosure, a screw portion or a washer is configured using a shape memory alloy, such that the screw portion or the washer is restored by application of a high temperature in a state of being engaged with an engagement portion, after the screw portion or the washer is processed at a low temperature, firmly maintaining bonding between the screw portion and the engagement portion and preventing unnecessary loosening.

### DESCRIPTION OF THE DRAWINGS

FIG. 1 illustrates an example of a dental implant according to conventional art.

FIG. 2 illustrates an example of screw loosening.

FIG. 3 illustrates a process of configuring a screw coupling structure for preventing loosening according to an embodiment of the present disclosure.

FIG. 4 illustrates a process of configuring a screw coupling structure for preventing loosening according to an embodiment of the present disclosure.

FIG. 5 illustrates a process of configuring a screw coupling structure for preventing loosening according to an embodiment of the present disclosure.

FIG. 6 illustrates a process of configuring a screw coupling structure for preventing loosening according to an embodiment of the present disclosure.

FIG. 7 illustrates a process of configuring a screw coupling structure for preventing loosening according to an embodiment of the present disclosure.

FIG. 8 illustrates a process of configuring a screw coupling structure for preventing loosening according to an embodiment of the present disclosure.

FIG. 9 shows deformation behaviors of a shape memory alloy used for a screw coupling structure for preventing loosening according to an embodiment of the present disclosure.

FIG. 10 illustrates manufacturing of a washer used for a screw coupling structure for preventing loosening according to an embodiment of the present disclosure.

### MODE OF THE INVENTION

Hereinafter, with reference to the accompanying drawings, preferable embodiments according to the present disclosure will be described. The current embodiment is not intended to be restrictive.

The advantages and/or characteristics of the present disclosure, and methods for achieving them can be clarified by referring to embodiments explained in detail below along with the accompanying drawings. However, the present disclosure is not limited to the disclosed embodiments but is implemented into various forms. The embodiments of the present invention are provided only to complete the disclosure of the present disclosure and let a person having ordinary knowledge in the art completely know the scope of the present disclosure. The present disclosure is defined only by the scope of claims. The same reference numerals through the specification refer to the same elements.

The terms used in the various exemplary embodiments of the present disclosure are for the purpose of describing particular exemplary embodiments only and are not intended to be limiting. As used herein, the singular forms are intended to include the plural forms as well, unless the context clearly indicates otherwise. In the present disclosure, an expression such as “comprises” and/or “comprising” indicates existence of a corresponding characteristic (such as an element such as a numerical value, function, operation, or component) and does not exclude existence of additional characteristic.

Entire terms (including a technical term and a scientific term) used here may have the same meaning as a meaning that may be generally understood by a person of common skill in the art. It may be analyzed that generally using terms defined in a dictionary have the same meaning as or a meaning similar to that of a context of related technology and are not analyzed as an ideal or excessively formal meaning unless explicitly defined.

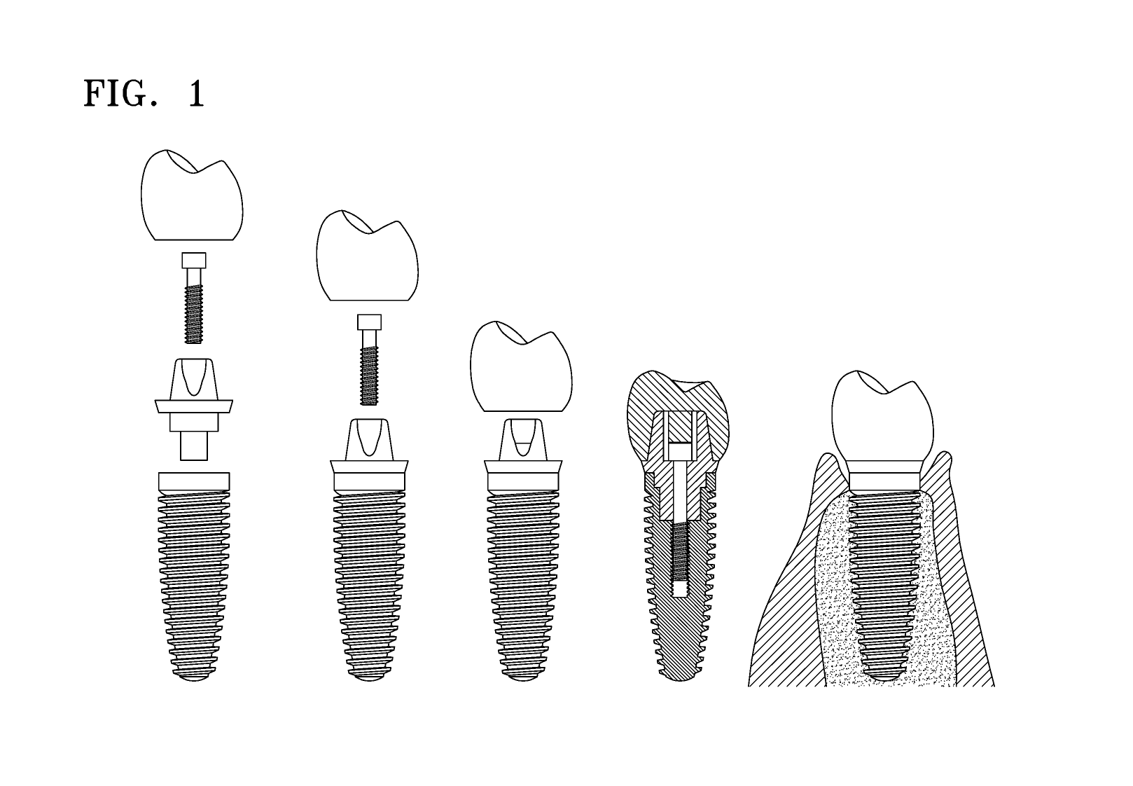

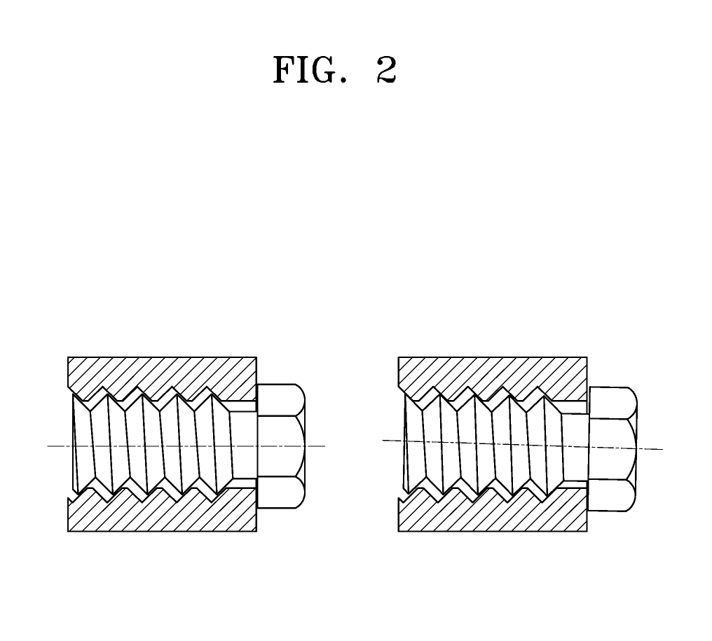

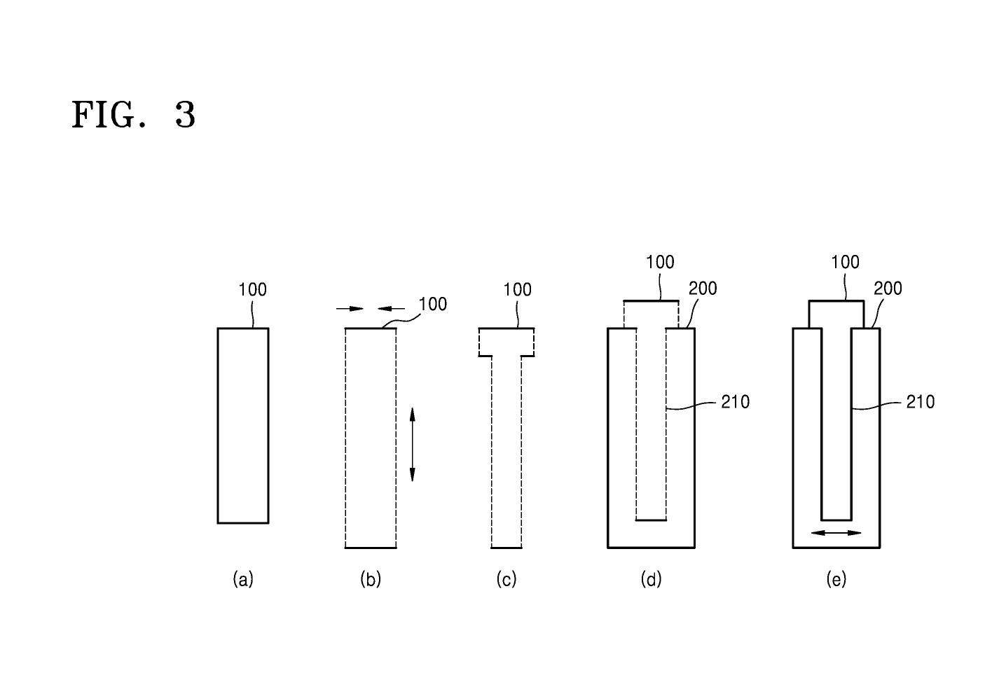

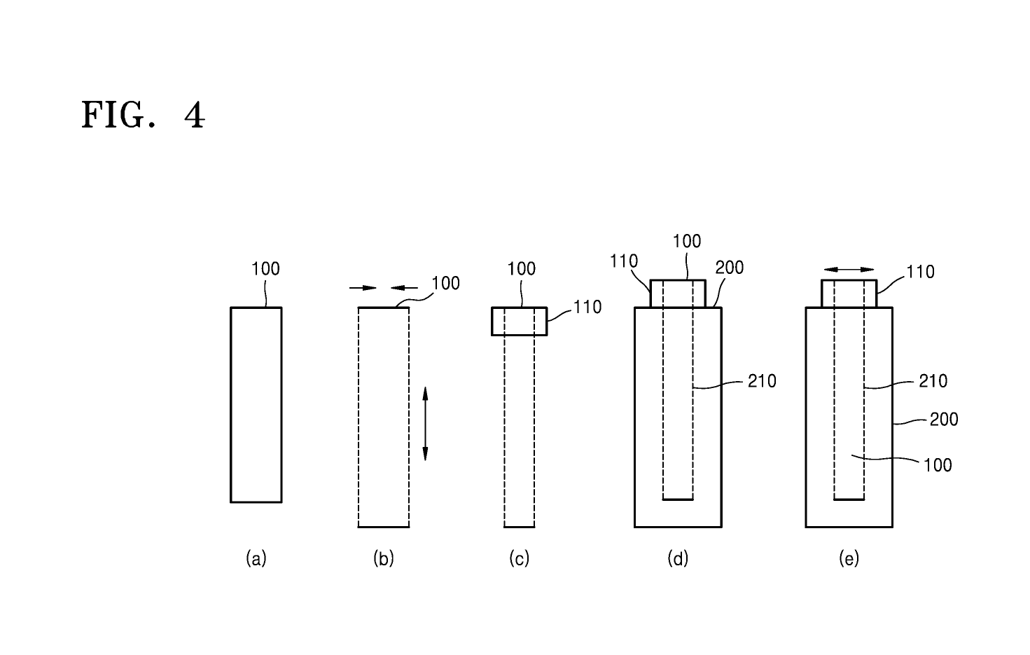

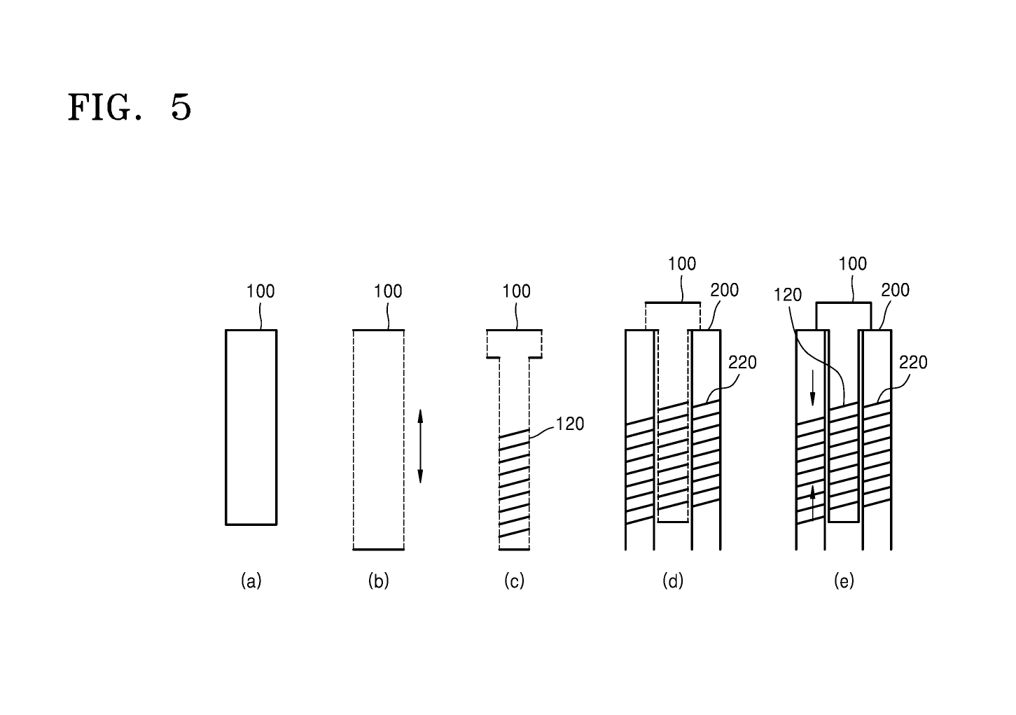

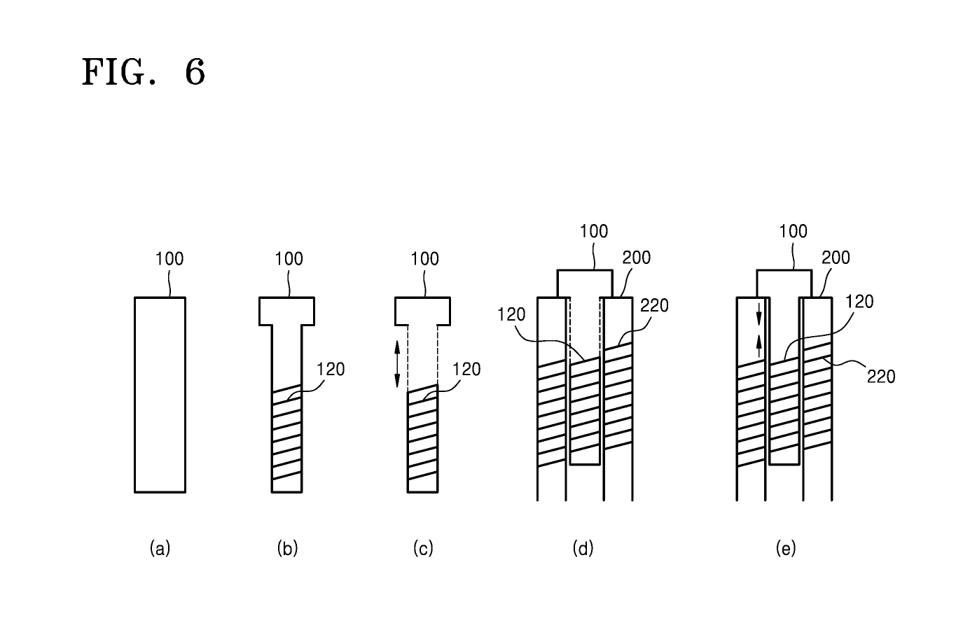

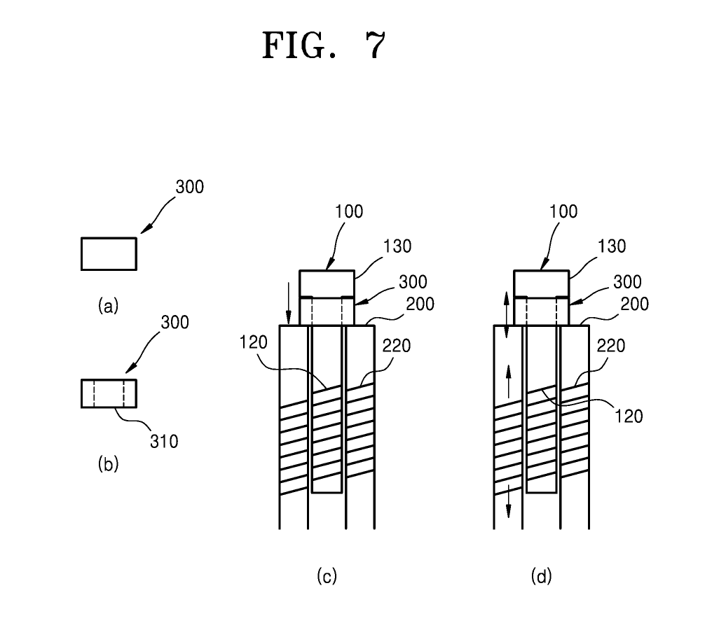

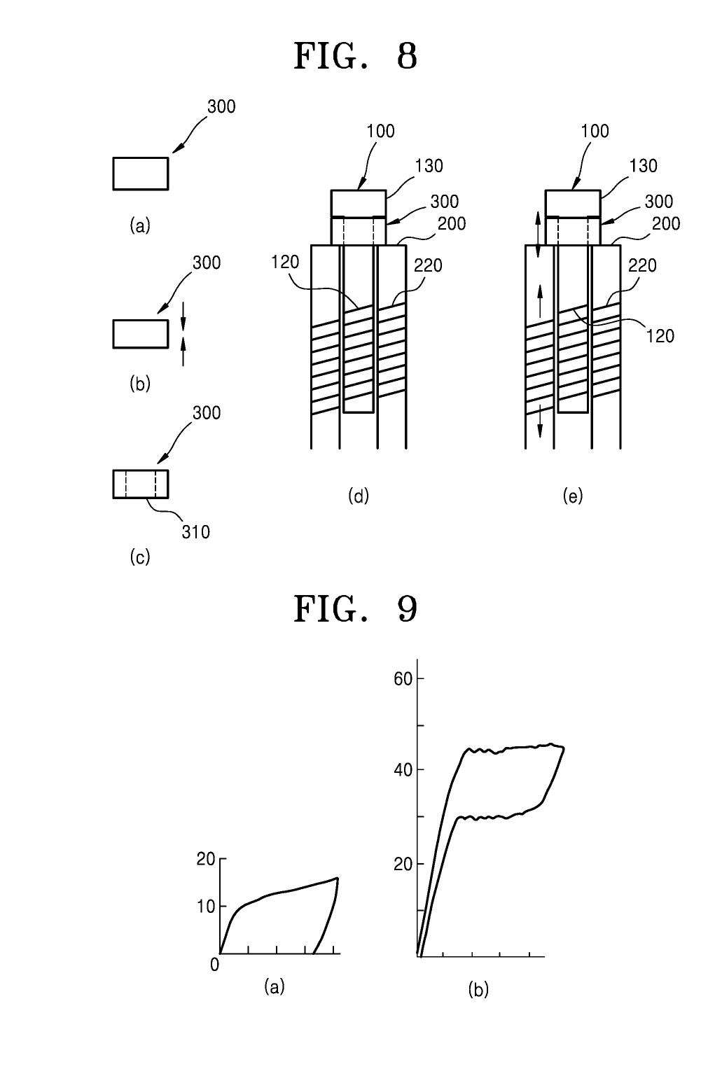

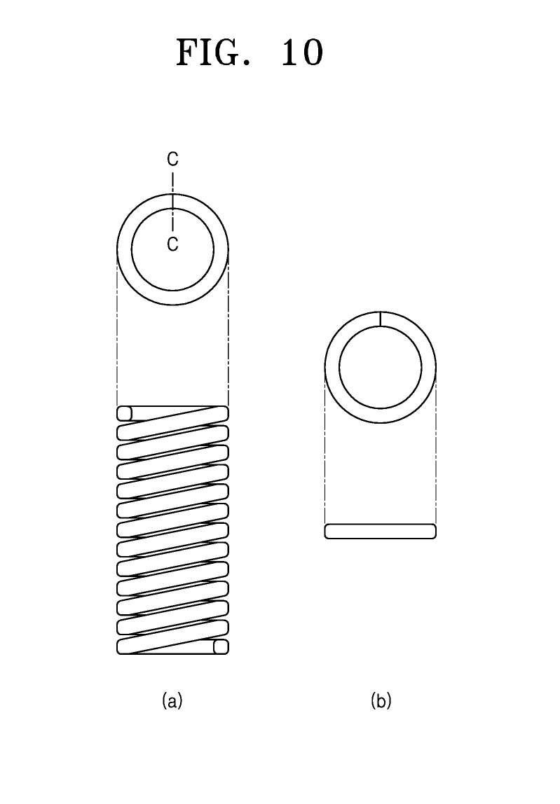

FIG. 1 illustrates an example of a dental implant according to conventional art, FIG. 2 illustrates an example of screw loosening, FIG. 3 illustrates a process of configuring a screw coupling structure for preventing loosening according to an embodiment of the present disclosure, FIG. 4 illustrates a process of configuring a screw coupling structure for preventing loosening according to an embodiment of the present disclosure, FIG. 5 illustrates a process of configuring a screw coupling structure for preventing loosening according to an embodiment of the present disclosure, FIG. 6 illustrates a process of configuring a screw coupling structure for preventing loosening according to an embodiment of the present disclosure, FIG. 7 illustrates a process of configuring a screw coupling structure for preventing loosening according to an embodiment of the present disclosure, FIG. 8 illustrates a process of configuring a screw coupling structure for preventing loosening according to an embodiment of the present disclosure, FIG. 9 shows deformation behaviors of a shape memory alloy used for a screw coupling structure for preventing loosening according to an embodiment of the present disclosure, and FIG. 10 illustrates manufacturing of a washer used for a screw coupling structure for preventing loosening according to an embodiment of the present disclosure.

(A) through (E) shown in FIGS. 3 through 8 illustrate a process of sequentially configuring a screw coupling structure for preventing loosening according to an embodiment of the present disclosure.

To achieve the foregoing objects, a screw coupling structure for preventing loosening for preventing loosening between a screw portion 100 and an engagement portion 200 includes the screw portion 100 extending to have a predetermined length and the engagement portion 200 having a screw hole 210 through which the screw portion 100 is inserted and engaged, in which the screw portion 100 is formed of a shape memory alloy deformable by an external force applied thereto at a temperature lower than a predetermined threshold temperature and is recoverable from the deformation by heating to a temperature higher than the threshold temperature.

As shown in FIG. 3, the screw coupling structure for preventing loosening according to the present disclosure may include the screw portion 100 extending to have the predetermined structure and the engagement portion 200 having the screw hole 210 through which the screw portion 100 is inserted and engaged.

The screw portion 100 may be a screw in the form of a predetermined beam without male screw threads 120 formed therein as shown in FIGS. 3 and 4, as well as a general screw having the male screw threads 120 formed therein, and the form of the screw portion 100 is not limited. The screw portion 100 extends to have the predetermined length.

The engagement portion 200 may be a predetermined nut or engagement member, and may be any member as long as the engagement portion 200 has formed therein the screw hole 210 which the screw portion 100 is inserted into and engaged with. The screw hole 210 formed in the engagement portion 200 may be a predetermined insertion hole into which the screw portion 100 in the form of a beam may be inserted, as well as a general screw hole having female screw threads 220 formed therein like the screw portion 100, and the form of the screw hole 210 is not limited.

The screw portion 100 is formed of a shape memory alloy deformable by an external force applied thereto at a temperature lower than a predetermined threshold temperature and is recoverable from the deformation by heating to a temperature higher than the threshold temperature. That is, the screw portion 100 may be deformed by application of an external force thereto at a temperature lower than the predetermined threshold temperature and then may be restored to the original state by heating to a temperature higher than the threshold temperature when the screw portion 100 is inserted into the engagement portion 200.

The deformation at the low temperature may be, for example, compression in the width direction of the screw portion 100. That is, the screw portion 100 is compressed in the width direction at a lower temperature than the threshold temperature, and upon application of a higher temperature than the threshold temperature to the screw portion 100 when the screw portion 100 is inserted into the screw hole 210 of the engagement portion 200, the screw portion 100 is restored to the original state in the width direction, exerting stress to the screw hole 210 in the width direction, such that the screw portion 100 and the engagement portion 200 may closely contact each other and firm binding between the screw portion 100 and the engagement portion 200 may be achieved.

The compression in the width direction of the screw portion 100 may include, but not limited thereto, stretching the screw portion 100 in the longitudinal direction of the screw portion 100 to compress the width of the screw portion 100 as well as directly compressing the screw portion 100 in the width direction of the screw portion 100. That is, in FIGS. 3 and 4, an arrow shown in (B) indicates compression and stretching of the screw portion 100 and an arrow shown in (E) indicates stretching after restoration.

In FIGS. 3 and 4, (A) through (E) show a configuration order, in which (B) and (C) indicate processing at a temperature lower than the threshold temperature, (D) indicates insertion at a temperature lower than the threshold temperature, and (E) indicates a state in which binding between the screw portion 100 and the engagement portion 200 is achieved after restoration of the screw portion 100 to the original state in an atmosphere of a temperature over the threshold temperature.

For example, if the diameter of the screw hole 210 is X and the diameter of the screw portion 100 is (X+A) greater than X, the screw portion 100 is pressurized or stretched at a temperature lower than the threshold temperature to have a width that is equal to or smaller than X. If the screw portion 100 is inserted into the screw hole 210 and then a temperature higher than the threshold temperature is applied, the screw portion 100 may tend to the original diameter of (X+A) and the screw portion 100 may exert a strong tightening force with respect to the screw hole 210 because the diameter of the screw hole 210 is X, giving an effect like forcibly inserting a screw having a diameter of (X+A) into the screw hole 210 having a diameter of X and thus giving a superior bonding force.

Such a configuration may also be applied to bonding of a predetermined disk 110 forming a predetermined head on the screw portion 100 as shown in FIG. 4. That is, before a high temperature is applied after deformation of the screw portion 100 at a low temperature, the predetermined disk 110 is inserted onto the screw portion 100 and the high temperature is applied to perform binding between the disk 110 and the screw portion 100.

FIGS. 5 and 6 illustrate a screw coupling structure for preventing loosening and a method for producing screw coupling structure for preventing loosening according to an embodiment of the present disclosure.

For example, the screw portion 100 has the male screw threads 120 formed on an outer surface and the engagement portion 200 has the female screw threads 220 formed on an inner surface of the screw hole 210. The screw portion 100 is at least partially compressed or stretched in the longitudinal direction at a temperature lower than the threshold temperature, and is heated to a temperature higher than the threshold temperature while being inserted into the engagement portion 200, thus being restored in the longitudinal direction and exerting stress on the male screw threads 120 and the female screw threads 220.

That is, as shown in FIGS. 5 and 6, the screw portion 100 has the male screw threads 120 and the screw hole 210 has the male screw threads 220. The screw portion 100 is at least partially compressed or stretched in the longitudinal direction at a temperature lower than the threshold temperature, and is heated to a temperature higher than the threshold temperature while being inserted into the engagement portion 200, thus being restored in the longitudinal direction. A longitudinal relative displacement between the male screw threads 120 formed in the screw portion 100 and the male screw threads 220 formed in the screw hole 210 is obtained, such that the male screw threads 120 and the female screw threads 220 adjacent thereto closely contact each other. Thus, superior bonding between the screw portion 100 and the screw hole 210 is achieved.

Close contact between the male screw threads 120 and the female screw threads 220 based on longitudinal displacement between the male screw threads 120 and the female screw threads 220 may be sufficient, such that the longitudinally compressed or stretched part of the screw portion 100 may be the entire longitudinal direction of the screw portion 100 as shown in FIG. 5 or may be a part of the longitudinal direction of the screw portion 100 as shown in FIG. 6, without being limited to those examples. Dotted parts of the screw portion 100 in FIGS. 5 and 6 indicate a longitudinally compressed or stretched state at a temperature lower than the threshold temperature. That is, the screw portion 100 is compressed or stretched as a whole in (B) through (D) of FIG. 5, whereas an upper part of the screw portion 100 is partially compressed or stretched in (D) and (E) of FIG. 6.

As the temperature changes back to a temperature higher than the threshold temperature, the screw portion 100 is longitudinally restored, thus being longitudinally compressed or stretched as shown in (F) of FIGS. 5 and 6. (F) of FIGS. 5 and 6 shows a state where the length is restored at a temperature higher than the threshold temperature, in which the screw portion 100 is illustrated with a solid line as a whole.

For example, if the screw portion 100 is longitudinally compressed or stretched as a whole, an interval between threads of the male screw threads 120 formed in the screw portion 100 are displaced, achieving firm contact with the female screw 220. If the screw portion 100 is partially compressed or stretched in the longitudinal direction, the threads of the male screw threads 120 formed in the screw portion 100 are displaced, achieving firm contact with the female screw 220.

Arrows indicated in (B) of FIG. 5 and (D) of FIG. 6 indicate stretching of the screw portion 100, and arrows indicated in (E) of FIG. 5 and (F) of FIG. 6 indicate stretching after restoration.

In FIGS. 5 and 6, (A) through (E) and (F) indicate a configuration order, in which (B) and (C) of FIG. 5 indicate processing at a temperature lower than the threshold temperature,

(D) indicates insertion at a temperature lower than the threshold temperature, and (E) indicates binding between the screw portion 100 and the engagement portion 200 after restoration of the screw portion 100 to the original state in an atmosphere of a temperature higher than the threshold temperature. Herein, (B) indicates overall stretching of the screw portion 100 at a temperature lower than the threshold temperature, such that firm binding is achieved by longitudinal restoration of the screw portion 100 in (E).

In FIG. 6, (D) indicates processing at a temperature lower than the threshold temperature, (E) indicates insertion at a temperature lower than the threshold temperature, and (F) indicates binding between the screw portion 100 and the engagement portion 200 after restoration of the screw portion 100 in an atmosphere of a temperature higher than the threshold temperature. The upper part of the screw portion 100 at a temperature lower than the threshold temperature is partially stretched in (D), such that the screw portion 100 is restored in the longitudinal direction in (E), achieving firm binding.

In this way, a method for producing screw coupling structure for preventing loosening according to the present disclosure may include providing the screw portion 100 formed of a shape memory alloy that extends to have a predetermined length and is restored by being heated to a temperature higher than a predetermined threshold temperature from deformation occurring at a temperature lower than the threshold temperature; providing the engagement portion 200 having the screw hole 210 through which the screw portion 100 is inserted; processing the screw portion 100 at a temperature lower than the threshold temperature;

performing engagement between the engagement portion 200 and the screw portion 100 by inserting the screw portion 100 into the screw hole 210; and restoring the screw portion 100 by heating the screw portion 100 to a temperature higher than the threshold temperature.

The processing of the screw portion 100 at a temperature lower than the threshold temperature may include stretching at least a part of the screw portion 100 in a longitudinal direction; and forming the male screw threads 120 portion 100 in the screw portion 100. The processing of the screw portion 100 at a temperature lower than the threshold temperature may include compressing the screw portion 100 in a width direction. That is, as mentioned regarding the screw coupling structure for preventing loosening, the processing of the screw portion 100 at a temperature lower than the threshold temperature may include deforming the screw portion 100 by stretching or compressing the screw portion 100, and the deformation is restored by heating to a temperature higher than the threshold temperature after engagement of the screw portion 100 with the engagement portion 200, such that firm binding between the screw portion 100 and the engagement portion 200 is formed.

FIGS. 7 and 8 illustrate a screw coupling structure for preventing loosening according to an embodiment of the present disclosure.

The screw coupling structure for preventing loosening according to an embodiment of the present disclosure may include the screw portion 100 that extends to have a predetermined length and has a head 130 in an upper portion thereof; the engagement portion 200 having the screw hole 210 through which the screw portion 100 is inserted and engaged; and a washer 300 disposed between the engagement portion 200 and the head 130 when the screw portion 100 is inserted into the engagement portion 200, in which the screw portion 100 has the male screw threads 120 formed on an outer surface thereof, the engagement portion 200 has the female screw threads 220 formed on an inner surface of the screw hole 210, and the washer 300 is formed of a shape memory alloy that is deformable by an external force applied thereto at a temperature lower than a predetermined threshold temperature and recoverable from the deformation by heating to a temperature higher than the threshold temperature.

According to the current embodiment of the present disclosure, the male screw threads 120 is formed in the screw portion 100, the head 130 is formed at a longitudinal end portion of the screw portion 100, and the female screw threads 220 is formed in the screw hole 210. In the current embodiment, the screw portion 100 is formed of general metal and is provided with the washer 300 formed of a shape memory alloy.

The washer 300 may have a configuration like a sort of nut. That is, the washer 300 may have a predetermined washer hole 310 through which the screw portion 100 may pass. Thus, the screw portion 100 is inserted into the screw hole 210 of the engagement portion 200 by passing through the washer 300, and once the screw portion 100 is completely inserted into the screw hole 210, the washer 300 is interposed between the head 130 of the screw portion 100 and the engagement portion 200. However, this configuration is a preferable embodiment, and the present disclosure is not limited to this example, such that the washer 300 may have any configuration as long as the washer 300 is interposed between the head 130 of the screw portion 100 and the engagement portion 200.

As the washer 300 is formed of a shape memory alloy, the washer 300 exerts a stress based on elastic deformation to the head 130 and the engagement portion 200 during engagement, allowing reliable engagement between the screw portion 100 and the engagement portion 200.

In this case, as the head 130 of the screw portion 100 is firmly pressurized against an upper portion of the washer 300 for strong engagement, the washer 300 may not be separately processed at a temperature lower than the threshold temperature. That is, as shown in (C) of FIG. 7, the washer 300 may be deformed and restored merely through strong pressurization of the head 130 of the screw portion 100 against the upper portion of the washer 300 without processing of the washer 300 at a temperature lower than the threshold temperature, achieving strong engagement between the screw portion 100 and the engagement portion 200.

In FIG. 7, an arrow shown in (C) indicates pressurization by the head 130 of the screw portion 100 and an arrow shown in (D) indicates stretching based on restoration.

In FIG. 7, (A) through (D) show such a configuration order. Herein, all of (A) through (D) may be achieved at a temperature higher than the threshold temperature.

As shown in FIG. 8, according to an embodiment of the present disclosure, preferably, the washer 300 is compressed longitudinally at a temperature lower than the threshold temperature, and the screw portion 100, when being inserted into the engagement portion 200, is disposed between the engagement portion 200 and the head 130. The screw portion 100 disposed between the engagement portion 200 and the head 130 is heated to a temperature higher than the threshold temperature and thus restored in the longitudinal direction, exerting stress on the male screw threads 120 and the female screw threads 220.

The washer 300 is interposed between the head 130 and the engagement portion 200 in a state of being compressed at a temperature lower than the threshold temperature, and then is restored to the original state by being applied with a temperature higher than the threshold temperature. At this time, the washer 300 is strongly interposed between the head 130 and the engagement portion 200, thus pressing an interval between the head 130 and the engagement portion 200 upon restoration of the washer 300. Thus, as in the foregoing embodiment, the screw portion 100 is finely displaced and the male screw 120 formed in the screw portion 100 is displaced relative to the female screw 220 formed in the screw hole 210, achieving close contact and bonding between the male screw 120 and the female screw 220.

According to the current embodiment of the present disclosure, it is not necessary to process the entire male screw 120 and only temperature application and processing with respect to the washer 300 are needed, reducing a processing cost and facilitating processing.

In FIG. 8, an arrow shown in (B) indicates compression of the washer 300 and an arrow shown in (E) indicates stretching based on restoration.

In FIG. 8, (A) through (E) indicate such a configuration order, in which (B) and (C) indicate processing at a temperature lower than the threshold temperature, (D) indicates insertion at a temperature lower than the threshold temperature, and (E) indicates binding between the screw portion 100 and the engagement portion 200 as the washer 300 pushes the screw portion 100 and the engagement portion 200 through restoration of the screw portion 100 to the original state in an atmosphere of a temperature higher than the threshold temperature.

Based on the foregoing process, a method for peoducing screw coupling structure for preventing loosening according to an embodiment of the present disclosure may include providing the screw portion 100 that extends to have a predetermined length and has the head 130 at an end thereof; providing the engagement portion 200 having the screw hole 210 through which the screw portion 100 is inserted; providing the washer 300 formed of a shape memory alloy that is deformed at a temperature lower than a predetermined threshold temperature and is recoverable from the deformation by being heated to a temperature higher than the threshold temperature; and engaging the engagement portion 200 with the screw portion 100 by inserting the screw portion 100 into the screw hole 210 to dispose the washer 300 between the head 130 and the engagement portion 200.

Preferably, the method may further include, between the providing of the washer and the disposing of the washer 300 between the head 130 and the engagement portion 200, compressing the washer 300 in a longitudinal direction by compressing the washer 300 at a temperature lower than the threshold temperature, and may include heating the washer 300 to a temperature higher than the threshold temperature to restore the washer 300 in the longitudinal direction after the disposing of the washer 300 between the head 130 and the engagement portion 200.

In the present disclosure, to bind the engagement portion 200 with the screw portion 100 by using the washer 300, the washer 300 is disposed between the head 130 of the screw portion 100 and the engagement portion 200. In addition, the washer 300 may be processed at a temperature lower than the threshold temperature, may be positioned between the engagement portion 200 and the head 130 of the screw portion 100, and then may be applied with a temperature higher than the threshold temperature for restoration. By forming engagement in this way, bonding between the screw portion 100 and the engagement portion 200 may be achieved.

In the method for producing screw coupling structure for preventing loosening according to the present disclosure, the threshold temperature may be in a range of about 20° C.—about 30° C., allowing the use of the screw coupling structure for preventing loosening manufactured by the method according to the present disclosure for the aforementioned implant applications.

FIG. 9 shows deformation behaviors of a shape memory alloy used for a screw coupling structure for preventing loosening according to an embodiment of the present disclosure.

Preferably, in the foregoing embodiment, the shape memory alloy may include an Ni—Ti alloy which has a deformation tendency as shown in the drawings. That is, as shown in (A) of FIG. 9, the alloy is easily deformed by application of a stress at a temperature lower than the threshold temperature and has a permanent deformation state in which partial deformation remains even after restoration from the deformation. However, if a temperature higher than the threshold temperature is applied to the alloy, the alloy is restored to the original state, which is called a “shape memory effect”, and a deformation of about 8% with respect to stretching or compression may be restored.

Suh a Ni—Ti alloy shows a shape memory effect and super-elasticity in a temperature range from a low temperature corresponding to liquid nitrogen to 200° C., and has an atomic ratio in which NI has an atom % of about 44—about 55 and the remaining part forms TI. In this composition, some elements of about 10% or less of NI and TI may be substituted by FE, CO, CR, AL, PD, or the like.

If the alloy is deformed at a temperature higher than the threshold temperature, a stress linearly increases with respect to the amount of deformation at an initial state like general metal, and then the stress is maintained constant in spite of increase of the amount of deformation. As the deformation is gradually released, the stress initially decreases and then is maintained constant, and finally, the stress linearly decreases like general metal. Since a high elasticity of about 8% is possible, a term “super-elasticity effect” is used.

When the alloy is deformed at a temperature lower than the threshold temperature and then is heated to a temperature higher than the threshold temperature, if the alloy is restrained from being restored to the original shape, then the alloy exerts a restoring force. The present disclosure uses such a property of the Ni—Ti alloy.

Preferably, the threshold temperature may range from about 20° C. to about 30° C. That is, the screw portion 100 or the washer 300 according to the present disclosure is processed at a temperature lower than about 20° C. or about 30° C., and then is restored to the original state at a temperature higher than that processing temperature. Thus, the screw coupling structure for preventing loosening according to the present disclosure may be applied to various body aids transplanted to a body. For example, for an implant, loosening of a screw may be an issue, but by applying the screw coupling structure for preventing loosening according to the present disclosure to a screw structure applied to the implant, the screw coupling structure for preventing loosening is processed at a temperature lower than the body temperature and then is restored to the original state by the body temperature when being transplanted to the body, thus exerting a strong bonding force and preventing the screw loosening problem of the implant. Meanwhile, unnecessary restoration due to the body temperature during transplantation may be solved by cooling with cold water.

The washer 300 may be manufactured in a way described below.

First, a coil formed of a Ni—Ti shape memory alloy is provided as in (A) of FIG. 10.

The coil preferably has a narrow winding interval. Preferably, the coil may be wound while contacting in a side direction as in (A) of FIG. 10. The coil may also be wound with a proper inner diameter according to the inner diameter of the washer 300 to be manufactured. A cross section of a line of the coil may have a globally quadrilateral shape. The quadrilateral square shape includes modified shapes, such as a quadrangle having rounded corners or having some curved portions, as well as an accurate quadrangle, but means a quadrilateral shape having four sides as a whole.

The coil is cut. The coil is cut in the diameter direction, in which only one side of the diameter is cut, instead of cutting both ends of the diameter to separate the cut coil in the form of a ring. That is, the coil is cut along a cutting line C-C in (A) of FIG. 10, such that the washer 300 in the form of a ring is separated from the coil as shown in (B) of FIG. 10. This cutting is performed in the longitudinal direction of the coil, allowing a configuration of the washer 300 with simple cutting without a complex operation.

That is, a member configured in the form of a coil is continuously cut in the longitudinal direction along the cut side in the diameter direction, simply manufacturing the washer 300 used in the screw coupling structure for preventing loosening according to the present disclosure.

The providing of the washer 300 may include providing a coil formed of a shape memory alloy; and providing a plurality of washers 300 in the form of a ring by cutting a side of the coil in the diameter direction along the longitudinal direction. By manufacturing the washer 300 in this way, one washer may be produced for each winding of the coil, preventing waste of a material and reducing mechanical processing.

While the exemplary embodiments of the present disclosure have been illustrated and described above, the present disclosure is not limited to the aforementioned specific exemplary embodiments, various modifications may be made by a person with ordinary skill in the art to which the present disclosure pertains without departing from the subject matters of the present disclosure that are claimed in the claims, and these modifications should not be appreciated individually from the technical spirit or prospect of the present disclosure.

1. A screw coupling structure for preventing loosening configured to prevent loosening between a screw portion and an engagement portion, the screw coupling structure for preventing loosening comprising:
a screw portion having a predetermined length; and
an engagement portion having a screw hole through which the screw portion is inserted and engaged,
wherein the screw portion is formed of a shape memory alloy deformable by an external force applied thereto at a temperature lower than a predetermined threshold temperature and recoverable from the deformation by heating to a temperature higher than the threshold temperature.

2. The screw coupling structure for preventing loosening of claim 1, wherein
the screw portion has male screw threads formed on an outer surface thereof,
the engagement portion has female screw threads formed on an inner surface of the screw hole, and
the screw portion is at least partially compressed or stretched in a longitudinal direction at a temperature lower than the threshold temperature, and, when heated to a temperature higher than the threshold temperature while being inserted into the engagement portion, expands or contracts in the longitudinal direction and recovers to a pre-deformed state, exerting stress on the male screw threads and the female screw threads.

3. The screw coupling structure for preventing loosening of claim 1, wherein the screw portion is compressed by being pressurized in a width direction at a temperature lower than the threshold temperature, and, when expanding in the width direction by being heated to a temperature higher than the threshold temperature while being inserted into the engagement portion, the screw portion exerts stress on the screw hole in the width direction.

4. A screw coupling structure for preventing loosening configured to prevent loosening between a screw portion and an engagement portion, the screw coupling structure for preventing loosening comprising:
a screw portion having a predetermined length and a head in an upper portion thereof;
an engagement portion having a screw hole through which the screw portion is inserted and engaged; and
a washer disposed between the engagement portion and the head when the screw portion is inserted into the engagement portion,
wherein the screw portion has male screw threads formed on an outer surface thereof, the engagement portion has female screw threads formed on an inner surface of the screw hole, and the washer is formed of a shape memory alloy deformable by an external force applied thereto at a temperature lower than a predetermined threshold temperature and recoverable from the deformation by heating to a temperature higher than the threshold temperature.

5. The screw coupling structure for preventing loosening of claim 4, wherein the washer is compressed in a longitudinal direction at a temperature lower than the threshold temperature, and, when heated to a temperature higher than the threshold temperature while disposed between the engagement portion and the head, expands in the longitudinal direction and recovers to a pre-deformed state, exerting stress on the male screw threads and the female screw threads.

6. The screw coupling structure for preventing loosening of claim 1 or 4, wherein the shape memory alloy comprises a Ni—Ti alloy.

7. The screw coupling structure for preventing loosening of claim 1 or 4, wherein the threshold temperature is in a range between about 20° C. and about 30° C.

8. An implant structure having the screw coupling structure for preventing loosening according to one of claims 1 to 4.

9. A method for producing screw coupling structure for preventing loosening, the method comprising:
providing a screw portion formed of a shape memory alloy deformable at a temperature lower than a predetermined threshold temperature and recoverable from the deformation by being heated to a temperature higher than the threshold temperature;
providing an engagement portion having a screw hole through which the screw portion is inserted;
treating the screw portion at a temperature lower than the threshold temperature;
engaging the engagement portion with the screw portion by inserting the screw portion into the screw hole; and
recovering the screw portion to a pre-deformed state by heating the screw portion to a temperature higher than the threshold temperature.

10. The method of claim 9, wherein the processing of the screw portion at a temperature lower than the threshold temperature comprises:
stretching or compressing at least a portion of the screw portion in a longitudinal direction; and
forming male screw threads in the screw portion.

11. The method of claim 9, wherein the processing of the screw portion at a temperature lower than the threshold temperature comprises compressing the screw portion in a width direction.

12. A method for producing screw coupling structure for preventing loosening, the method comprising:
providing a screw portion having a predetermined length and a head at an end portion thereof;
providing an engagement portion having a screw hole through which the screw portion is inserted;
providing a washer formed of a shape memory alloy that is deformed at a temperature lower than a predetermined threshold temperature and is recoverable from the deformation by being heated to a temperature higher than the threshold temperature; and
engaging the engagement portion with the screw portion by inserting the screw portion into the screw hole, wherein the engaging comprises disposing the washer between the head and the engagement portion.

13. The method of claim 12, further comprising:
between the providing of the washer and the disposing of the washer between the head and the engagement portion, compressing the washer in a longitudinal direction by compressing the washer at a temperature lower than the threshold temperature; and
after the disposing of the washer between the head and the engagement portion, heating the washer to a temperature higher than the threshold temperature to expand the washer in the longitudinal direction and recover the washer to a pre-deformed state.

14. The method of claim 12, wherein the providing of the washer comprises:
providing a coil formed of a shape memory alloy; and
providing a plurality of washers having a shape of ring, wherein the providing of the washer comprises longitudinally cutting a side of the coil in a diameter direction.
